(19) United States
(12) Patent Application Publication
(10) Pub. No.: US 2026/0149799 A1
(43) Pub. Date: May 28, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Toshimitsu KANEKO, Kawasaki (JP); Tatsuya TANAKA, Ichikawa (JP)

(73) Assignee: KABUSHIKI KAISHA TOSHIBA, Tokyo (JP)

(21) Appl. No.: 19/237,200

(22) Filed: Jun. 13, 2025

(30) Foreign Application Priority Data
Nov. 25, 2024 (JP) 2024-204604

(51) Int. Cl. H04N 19/102; G06N 3/092

(52) U.S. Cl. CPC H04N 19/102; G06N 3/092

(57) ABSTRACT

An information processing apparatus includes a data-augmentation unit and a learning unit. The data-augmentation unit generates one or more pieces of augmented experience data in which at least a buffer-occupancy rate bₜ₋₁ included in experience data is changed to a different value based on the experience data including a state sₜ₋₁ that is a state of encoding a (t-1)-th image included in a moving image and includes the buffer-occupancy rate bₜ₋₁, a reward rₜ representing an evaluation value of encoding of the (t-1)-th image, an action aₜ₋₁ obtained by a model receiving an input of the state sₜ₋₁ and outputting an action for determining parameters of encoding, and a state sₜ that is a state of encoding a t-th image included in the moving image and includes a buffer-occupancy rate bₜ. The learning unit learns the model using the experience data and the augmented experience data.

### CROSS-REFERENCE TO RELATED APPLICATIONS

This application is based upon and claims the benefit of priority from Japanese Patent Application No. 2024-204604, filed on Nov. 25, 2024; the entire contents of which are incorporated herein by reference.

### FIELD

Embodiments described herein relate generally to an information processing apparatus, an information processing method, and a computer program product.

### BACKGROUND

A moving image has a large data amount, and accordingly, data compression by moving image encoding is performed at the time of transmission via a network and at the time of storage in a storage device. It is preferable that image quality degradation due to encoding be as small as possible, however, in order to satisfy limitations such as an assumed bandwidth of a network and a capacity of a storage device, it is necessary to suppress the data amount after encoding to a certain amount or less.

For the purpose of minimizing image quality degradation under data amount constraints, control of encoding parameters (rate control) is performed. Moving image encoding is complex processing using interframe and intra-frame correlation, frequency component bias, and the like, and it is difficult to accurately predict the image quality and the data amount before encoding. As such, it is difficult to manually optimize rate control.

Accordingly, a technique for optimizing rate control using reinforcement learning has been proposed. By such a technique, rate control is optimized from data (experience data) obtained by trial and error of moving image encoding, and thus it is possible to perform better rate control than in a case of manual design.

### BRIEF DESCRIPTION OF THE DRAWINGS

FIG. 1 is a block diagram of an information processing apparatus according to an embodiment;

FIG. 2 is a block diagram of a rate control unit;

FIG. 3 is a diagram illustrating an example of experience data and augmented experience data;

FIG. 4 is a flowchart of data augmentation processing according to the embodiment;

FIG. 5 is a diagram for describing an effect of data augmentation;

FIG. 6 is a diagram for describing an effect of data augmentation;

FIG. 7 is a diagram illustrating an example of a designation screen; and

FIG. 8 is a hardware configuration diagram of the information processing apparatus according to the embodiment.

### DETAILED DESCRIPTION

According to an embodiment, an information processing apparatus includes at least one hardware processor. The hardware processor is configured to generate one or more pieces of augmented experience data in which at least a buffer occupancy rate bₜ₋₁ included in experience data is changed to a different value on a basis of the experience data including a state sₜ₋₁ that is a state of encoding of a (t-1)-th image included in a moving image and includes the buffer occupancy rate bₜ₋₁, a reward rₜ that represents an evaluation value of encoding of the (t-1)-th image, an action aₜ₋₁ obtained by a model that receives an input of the state sₜ₋₁ and outputs an action used for determining parameters of encoding, and a state sₜ that is a state of encoding of a t-th image included in the moving image and includes a buffer occupancy rate bₜ. The hardware processor is configured to learn the model using the experience data and the augmented experience data.

Hereinafter, a preferred embodiment of an information processing apparatus according to the present disclosure will be described in detail with reference to the accompanying drawings. The present disclosure is not limited to the following embodiments.

In reinforcement learning of rate control, rate control is optimized for experience data obtained by trial and error performed during learning. Therefore, rate control is not learned for an image change that has not occurred during learning. For example, consider a case where rate control is learned for a moving image with a small change, such as a monitoring image in a room without a person and a monitoring image of a device without movement. In a case where such a moving image is targeted, when reinforcement learning advances to some extent and rate control can be performed, the data amount after encoding concentrates in a narrow range for each position of a frame in a group of pictures (GOP).

In a case where a moving image is transmitted via a network, data before transmission is temporarily accumulated in a transmission buffer. When the data amount concentrates in a specific range, the data amount in the transmission buffer also concentrates in a narrow range for each position of a frame in the GOP. The data amount in the transmission buffer can be represented as the occupancy rate of the transmission buffer (hereinafter, buffer occupancy rate). The buffer occupancy rate is one piece of information used to determine encoding parameters in rate control. As described above, in a case where a moving image with a small change is targeted, the buffer occupancy rate takes only values within a specific range during learning, and thus control outside the range cannot be appropriately learned.

As a result, for example, when the rate control operation is performed by use of a rate control model obtained by the reinforcement learning, there is a possibility that an image change that has not occurred at the time of learning occurs, the buffer occupancy rate deviates from the learned range, and appropriate rate control cannot be performed. Note that the rate control model is, for example, a model learned to receive an input of a state of encoding and output an action used to determine the encoding parameters. Learning the rate control model so as to optimize the action for the state corresponds to optimizing (learning) rate control.

The information processing apparatus according to the embodiment generates data (augmented experience data) of various buffer occupancy rates from experience data for one time by data augmentation regarding a buffer occupancy rate, and uses the data for learning. As a result, it is possible to learn rate control at a buffer occupancy rate that has not occurred at the time of learning without decreasing the learning efficiency, which makes it possible to execute more stable rate control.

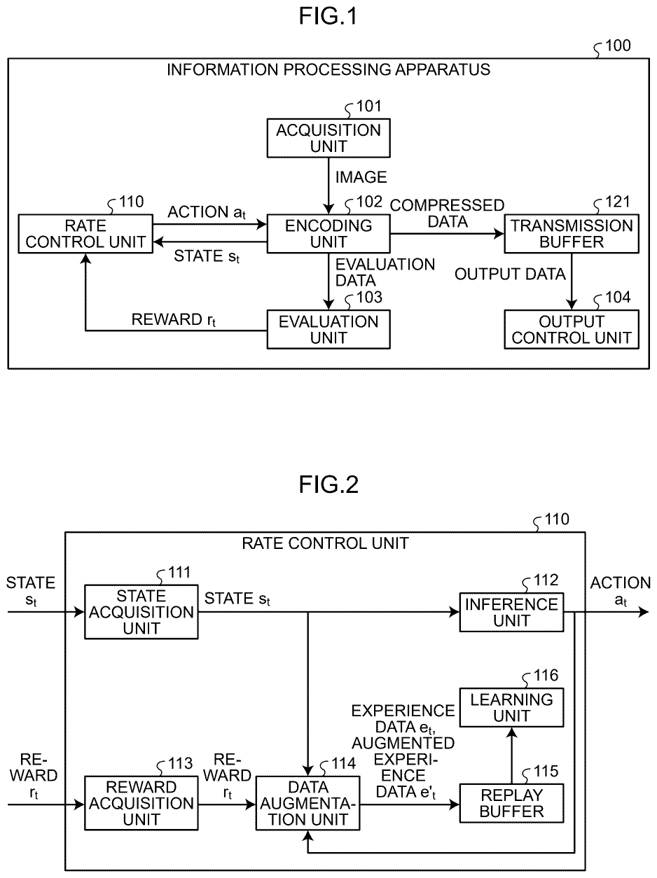

FIG. 1 is a block diagram illustrating an example of a configuration of an information processing apparatus 100 according to the embodiment. As illustrated in FIG. 1, the information processing apparatus 100 includes a transmission buffer 121, an acquisition unit 101, an encoding unit 102, an evaluation unit 103, an output control unit 104, and a rate control unit 110.

The transmission buffer 121 temporarily stores data encoded by the encoding unit 102 (compressed data) before the data is output (transmitted) as output data by the output control unit 104.

The acquisition unit 101 acquires various types of information to be used in the information processing apparatus 100. For example, the acquisition unit 101 acquires a moving image to be encoded, and outputs images included in the moving image to the encoding unit 102 in units of one frame. The method of acquiring information by the acquisition unit 101 may be any method, and for example, it is possible to apply a method of receiving information from an external device via a network, a method of reading information from a storage medium, and the like.

The encoding unit 102 encodes the images input from the acquisition unit 101 to reduce the data amount. The encoding method may be any method, and for example, it is possible to use MPEG-2, MPEG-4, H.264, H.265, and the like. The encoding unit 102 stores the encoded data (compressed data) in the transmission buffer 121.

When encoding a t-th image Iₜ input from the acquisition unit 101, the encoding unit 102 sends a state sₜ of encoding to the rate control unit 110. The state sₜ is data including, for example, the following elements, and is used by the rate control unit 110 to determine an action aₜ.
Image Iₜ
Buffer occupancy rate bₜ
Position pₜ of image Iₜ in GOP
Data amount vₜ₋₁, . . . , v_{t-M} of compressed data corresponding to M (M is integer of 1 or more) images Iₜ₋₁, . . . , I_{t-M} at times before image Iₜ
Encoding parameters qₜ₋₁, . . . , q_{t-M} used to encode images Iₜ₋₁, . . . , I_{t-M}

The encoding parameters are, for example, a quantization parameter (QP), lambda, and the like. The buffer occupancy rate bₜ is a rate of the data amount stored in the transmission buffer 121 with respect to a fixed value at a timing immediately before encoding the image Iₜ. The fixed value is, for example, an upper limit value of the data amount that can be stored in the transmission buffer 121. The fixed value may be determined as a value at which no delay occurs in processing (display or the like) on the side of receiving the compressed data.

The encoding unit 102 receives the action aₜ determined for the state sₜ from the rate control unit 110. The action aₜ is, for example, a continuous value within a certain range, such as −1 to 1, or an integer value within a certain range, such as 0 to 51. The encoding unit 102 converts the action aₜ into encoding parameters by predetermined conversion processing (linear transformation, integer approximation, or the like), and encodes the image Iₜ using the encoding parameters obtained by the conversion. The conversion processing may be executed in the rate control unit 110.

Furthermore, the encoding unit 102 outputs evaluation data to the evaluation unit 103. The evaluation data is data for evaluating image quality, and includes, for example, an image before encoding, an image obtained by decoding compressed data, a buffer occupancy rate, and the like.

The evaluation unit 103 evaluates the image quality of the compressed data using the evaluation data. For example, the evaluation unit 103 calculates a reward rₜ to be used for learning of the rate control model and outputs the reward rₜ to the rate control unit 110. The reward rₜ represents an evaluation value of encoding (result of rate control) for an image before the t-th image. The reward rₜ is calculated such that a smaller value is obtained as a distortion caused by the encoding of the image is larger, and a larger value is obtained as the distortion is smaller. The distortion is calculated by, for example, a mean squared error between the image before encoding and the image after decoding the compressed data, a peak signal-to-noise ratio (PSNR), a structural similarity (SSIM), or the like. In addition, in a case where the buffer occupancy rate exceeds a predetermined threshold, the reward rₜ is calculated such that a smaller value is obtained as the amount exceeding the threshold is larger, and a larger value is obtained as the amount exceeding the threshold is smaller. The threshold is determined from, for example, a buffer occupancy rate value at which a delay is expected to occur in image display on the reception side when compressed data is transmitted via a network.

The output control unit 104 controls output of various types of information to be used in the information processing apparatus 100. For example, the output control unit 104 extracts some or all of the compressed data stored in the transmission buffer 121 in the order of storage, and transmits the extracted compressed data to a network.

At the time of inference using the learned rate control model, the rate control unit 110 determines the action aₜ from the state sₜ output from the encoding unit 102 and outputs the action aₜ to the encoding unit 102. At the time of learning, the rate control unit 110 learns the rate control model using the reward rₜ output from the evaluation unit 103.

At least a part of the above units (the acquisition unit 101, the encoding unit 102, the evaluation unit 103, the output control unit 104, and the rate control unit 110.) may be implemented by one or more processing units. Each of the above units is implemented by, for example, one or a plurality of processors. For example, each of the above units may be implemented by a processor such as a central processing unit (CPU) and a graphics processing unit (GPU) executing a program, that is, by software. Each of the above units may be implemented by a processor such as a dedicated integrated circuit (IC), that is, by hardware. Each of the above units may be implemented by software and hardware being used in combination. In a case where a plurality of processors is used, each processor may implement one of the units or two or more of the units.

Next, details of the configuration of the rate control unit 110 will be described. FIG. 2 is a block diagram illustrating an example of the configuration of the rate control unit 110. As illustrated in FIG. 2, the rate control unit 110 includes a state acquisition unit 111, an inference unit 112, a reward acquisition unit 113, a data augmentation unit 114, a replay buffer 115, and a learning unit 116.

Note that, for example, each unit illustrated in FIG. 2 is used at the time of learning the rate control model. At the time of inference using the learned rate control model, for example, the state acquisition unit 111 and the inference unit 112 are used among the units illustrated in FIG. 2.

The state acquisition unit 111 acquires the state sₜ from the encoding unit 102 and transmits the state sₜ to the inference unit 112 and the data augmentation unit 114.

At the time of inference, the inference unit 112 inputs the state sₜ to the rate control model and outputs the action aₜ, which is an output of the rate control model, to the encoding unit 102. At the time of learning, the inference unit 112 sends the action aₜ to the encoding unit 102 and the data augmentation unit 114.

The rate control model may be a model of any form, and is, for example, a model using a neural network, a linear function, a decision tree, a Gaussian process, and the like.

The reward acquisition unit 113 acquires the reward rₜ output by the evaluation unit 103 and transmits the reward rₜ to the data augmentation unit 114.

The data augmentation unit 114 generates experience data as a source of data augmentation, generates augmented experience data obtained by editing the experience data, and stores each generated data in the replay buffer 115. The experience data and the augmented experience data are data to be used for learning of the rate control model (learning data).

For example, the data augmentation unit 114 generates experience data eₜ including a state sₜ₋₁ of encoding of a (t-1)-th image included in the moving image, the reward rₜ for encoding of the (t-1)-th image, an action aₜ₋₁ obtained by the rate control model to which the state sₜ₋₁ is input, and the state sₜ of encoding of the t-th image included in the moving image, and stores the experience data eₜ in the replay buffer 115.

In addition, on the basis of the experience data eₜ, the data augmentation unit 114 generates one or more pieces of augmented experience data e′ₜ in which at least a buffer occupancy rate bₜ₋₁ in the state sₜ₋₁ included in the experience data eₜ is changed to a different value, and stores the generated augmented experience data e′ₜ in the replay buffer 115.

The method of generating the augmented experience data will be described in detail. First, the data augmentation unit 114 calculates a buffer occupancy rate b′ₜ₋₁ obtained by changing the buffer occupancy rate bₜ₋₁ to a different value. For example, the data augmentation unit 114 calculates the buffer occupancy rate b′ₜ₋₁ on the basis of a value obtained by adding a random number (noise) to the buffer occupancy rate bₜ₋₁.

The random number may be generated in any manner, and for example, it is possible to apply a method of sampling from a normal distribution having an average of 0 and a variance σ. A probability distribution other than the normal distribution, such as a uniform distribution in a certain range, may be used.

The data augmentation unit 114 calculates a reward r′ₜ using the buffer occupancy rate b′ₜ₋₁. The method of calculating the reward r′ₜ is similar to the method of calculating a reward by the evaluation unit 103. The data augmentation unit 114 calculates the reward r′ₜ by using the buffer occupancy rate b′ₜ₋₁ instead of the buffer occupancy rate bₜ₋₁. That is, in a case where the buffer occupancy rate b′ₜ₋₁ exceeds a predetermined threshold, the data augmentation unit 114 calculates the reward r′ₜ such that a smaller value is obtained as the amount exceeding the threshold is larger, and a larger value is obtained as the amount exceeding the threshold is smaller.

The data augmentation unit 114 calculates a buffer occupancy rate b′ₜ using the buffer occupancy rate b′ₜ₋₁. The buffer occupancy rate b′ₜ corresponds to a buffer occupancy rate obtained by simulating encoding of the moving image in a case where the buffer occupancy rate one frame before is b′ₜ₋₁.

For example, the data augmentation unit 114 calculates the buffer occupancy rate b′ₜ by using an update model that receives inputs of the buffer occupancy rate b′ₜ₋₁, a network bandwidth, and the compressed data amount of one or more images before the (t-1)-th image and outputs the buffer occupancy rate b′ₜ. The update model is represented by the following Formula (1) using, for example, the buffer occupancy rate b′ₜ₋₁, the compressed data amount vₜ₋₁, and an assumed network bandwidth B. max(x, y) is a function that outputs the value of the larger one of x or y.

$${b}_{t}^{′} = max ( {b}_{t - 1}^{′} - B , 0 ) + {v}_{t - 1} \qquad ( 1 )$$

The data augmentation unit 114 generates the augmented experience data e′ₜ in which the buffer occupancy rate bₜ₋₁, the reward rₜ, and the buffer occupancy rate bₜ included in the experience data eₜ are replaced with the buffer occupancy rate b′ₜ₋₁, the reward r′ₜ, and the buffer occupancy rate b′ₜ, respectively.

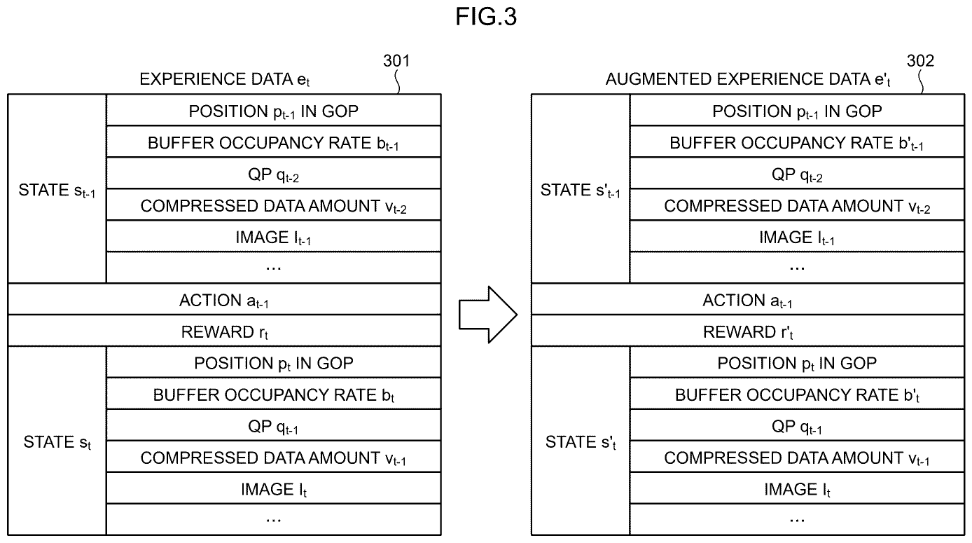

FIG. 3 is a diagram illustrating an example of the experience data eₜ and the augmented experience data e′ₜ. Data 301 and data 302 are examples of the experience data eₜ and the augmented experience data e′ₜ, respectively.

In the example of FIG. 3, the experience data eₜ includes the state sₜ₋₁, the state sₜ, the action aₜ₋₁, and the reward rₜ. The state sₜ₋₁ includes a position pₜ₋₁ of an image Iₜ₋₁ in GOP, a buffer occupancy rate bₜ₋₁, QP qₜ₋₂ representing an encoding parameter, a compressed data amount vₜ₋₂, and an image Iₜ₋₁. The state sₜ includes a position pₜ of an image Iₜ in GOP, a buffer occupancy rate bₜ, QP qₜ₋₁ representing an encoding parameter, a compressed data amount vₜ₋₁, and an image Iₜ. The augmented experience data e′ₜ corresponds to data simulating a buffer occupancy rate different from that of the experience data eₜ. The augmented experience data e′ₜ is data for enabling the rate control model to learn control at various buffer occupancy rates.

The data 302 is an example of the augmented experience data generated by editing the data 301 (experience data eₜ). Data included in a state s′ₜ₋₁ of the data 302 is almost the same as data included in the state sₜ₋₁ of the data 301, but is different in that the buffer occupancy rate bₜ₋₁ is changed to the buffer occupancy rate b′ₜ₋₁. In addition, data included in a state s′ₜ of the data 302 is almost the same as data included in the state sₜ of the data 301, but is different in that the buffer occupancy rate bₜ is changed to the buffer occupancy rate b′ₜ.

The description returns to FIG. 2. The replay buffer 115 is a buffer for storing data input from the data augmentation unit 114. The experience data and the augmented experience data are input from the data augmentation unit 114, but the replay buffer 115 does not distinguish between the experience data and the augmented experience data and stores both as experience data. In a case where the number of pieces of experience data to be stored reaches the upper limit value, the replay buffer 115 deletes old experience data and stores new experience data. When the learning unit 116 learns the rate control model, the replay buffer 115 samples a certain number of pieces of experience data and inputs the experience data to the learning unit 116.

The learning unit 116 learns the rate control model by using the experience data (experience data and augmented experience data) output from the replay buffer 115. The rate control model to be learned is common to the rate control model used by the inference unit 112 to calculate an action. As a learning algorithm, for example, it is possible to use a reinforcement learning algorithm using experience data, such as a deep Q-network (DON), a soft actor critic (SAC), a deep deterministic policy gradient (DDPG), and a twin-delayed DDPG (TD3).

Note that the transmission buffer 121 and the replay buffer 115 can be each configured by any generally used storage medium such as a flash memory, a memory card, a random access memory (RAM), a hard disk drive (HDD), and an optical disc.

The transmission buffer 121 and the replay buffer 115 may be physically different storage media, or may be implemented as different storage areas of the physically same storage medium. Furthermore, each of the transmission buffer 121 and the replay buffer 115 may be implemented by a plurality of physically different storage media.

Furthermore, the information processing apparatus 100 may be physically configured by one apparatus or may be physically configured by a plurality of apparatuses. For example, the information processing apparatus 100 may be constructed on a cloud environment. Furthermore, each unit in the information processing apparatus 100 may be dispersedly provided in a plurality of apparatuses.

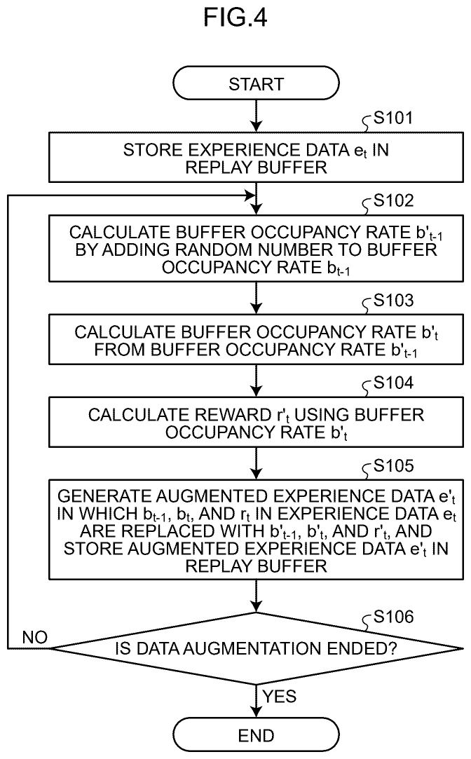

Next, data augmentation processing by the information processing apparatus 100 according to the embodiment will be described. FIG. 4 is a flowchart illustrating an example of data augmentation processing according to the embodiment.

The data augmentation processing is processing of editing one piece of experience data to generate one or more pieces of augmented experience data. The data augmentation processing is executed for each of one or more pieces of experience data, for example, before the reinforcement learning of the rate control model is executed.

The data augmentation unit 114 stores the experience data eₜ as a target of data augmentation in the replay buffer 115 (step S101). Subsequent steps S102 to S105 correspond to processing of generating augmented experience data.

The data augmentation unit 114 calculates the buffer occupancy rate b′ₜ₋₁ by adding a random number to the buffer occupancy rate bₜ₋₁ included in the experience data eₜ (step S102).

The data augmentation unit 114 calculates the buffer occupancy rate b′ₜ from the buffer occupancy rate b′ₜ₋₁ by using, for example, an update model such as Formula (1) (step S103).

The data augmentation unit 114 calculates the reward r′ₜ in a case where the buffer occupancy rate is b′ₜ by using the buffer occupancy rate b′ₜ (step S104).

The data augmentation unit 114 generates the augmented experience data e′ₜ in which the buffer occupancy rate bₜ₋₁, the buffer occupancy rate bₜ, and the reward rₜ included in the experience data eₜ are replaced with the buffer occupancy rate b′ₜ₋₁, the buffer occupancy rate b′ₜ, and the reward r′ₜ, respectively, and stores the augmented experience data e′ₜ in the replay buffer (step S105).

The data augmentation unit 114 determines whether to end the data augmentation (step S106). For example, in a case where a predetermined number of pieces of the augmented experience data e′ₜ are generated from the experience data eₜ, the data augmentation unit 114 determines to end the data augmentation.

In a case where the data augmentation is not ended (step S106: No), the data augmentation unit 114 returns to step S102 and repeats the processing. In a case where the data augmentation is ended (step S106: Yes), the data augmentation unit 114 ends the data augmentation processing.

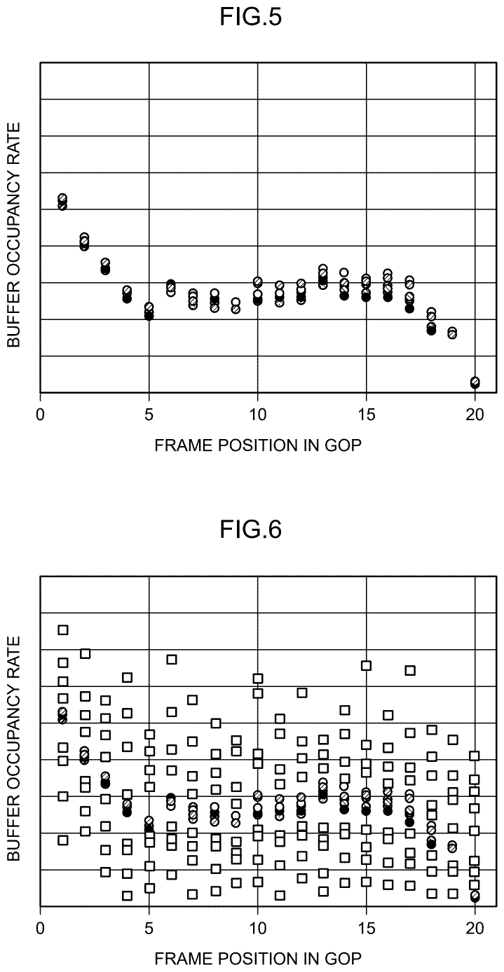

FIGS. 5 and 6 are diagrams for describing effects of data augmentation. FIG. 5 is a diagram in which buffer occupancy rates at the time of learning rate control for a moving image with a small screen change without using augmented experience data are plotted for each position of a frame in a GOP. When the learning progresses and a certain level of rate control can be executed, the buffer occupancy rates concentrate in a narrow range for each position of a frame in the GOP, and data outside the range hardly occurs.

FIG. 6 is a diagram in which buffer occupancy rates at the time of learning rate control with the addition of augmented experience data generated by the data augmentation unit 114 are plotted for each position of a frame in the GOP. Squares represent buffer occupancy rates corresponding to the augmented experience data. Since the augmented experience data including various buffer occupancy rates is added to the learning data, control for a screen change that has not occurred during learning can also be learned.

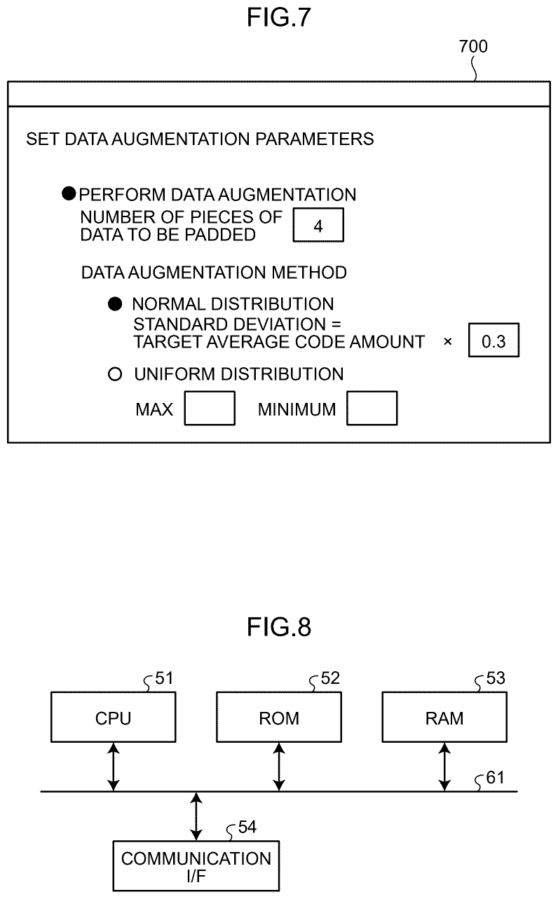

Next, an example of a user interface (designation screen) for designating a setting value used for generating augmented experience data will be described. FIG. 7 is a diagram illustrating an example of a designation screen.

For example, the output control unit 104 displays a designation screen 700 as illustrated in FIG. 7 on a display device included in the information processing apparatus 100 or a display device outside the information processing apparatus 100. The data augmentation unit 114 generates augmented experience data using setting values designated by use of the designation screen. The setting values designated on the designation screen include, for example, the number of pieces of augmented experience data to be generated and a method of changing the buffer occupancy rate to different values.

In the example of FIG. 7, the number of pieces of data to be padded corresponds to the number of pieces of augmented experience data to be generated, and the data augmentation method corresponds to the method of changing the buffer occupancy rate to different values. FIG. 7 illustrates an example in which it is possible to designate, as a data augmentation method, whether to use the normal distribution or the uniform distribution at the time of sampling random numbers to be added to the buffer occupancy rate.

In a case where the normal distribution is selected, a standard deviation can be designated. In a case where the uniform distribution is selected, an upper limit and a lower limit can be designated. Note that, for selection of the probability distribution and input of the numerical value, input devices such as a keyboard, a mouse, and a touch panel are used.

As described above, the information processing apparatus according to the embodiment generates augmented experience data of various buffer occupancy rates and uses the generated augmented experience data for learning of the rate control model. As a result, it is possible to learn rate control at a buffer occupancy rate that has not occurred at the time of learning, and it is possible to execute more stable rate control for encoding a moving image.

Next, a hardware configuration of the information processing apparatus according to the embodiment will be described with reference to FIG. 8. FIG. 8 is an explanatory diagram illustrating a hardware configuration example of the information processing apparatus according to the embodiment.

The information processing apparatus according to the embodiment includes a control device such as a central processing unit (CPU) 51, a storage device such as a read only memory (ROM) 52 or a random access memory (RAM) 53, a communication I/F 54 that is connected to a network and performs communication, and a bus 61 that connects each unit.

The program executed by the information processing apparatus according to the embodiment is provided by being incorporated in the ROM 52 or the like in advance.

The program executed by the information processing apparatus according to the embodiment may be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing apparatus according to the embodiment may be stored on a computer connected to a network such as the Internet and provided by being downloaded via the network. Furthermore, the program executed by the information processing apparatus according to the embodiment may be provided or distributed via a network such as the Internet.

The program executed by the information processing apparatus according to the embodiment can cause a computer to function as each unit of the information processing apparatus described above. In this computer, the CPU 51 can read the program from a computer-readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
at least one hardware processor configured to:
generate one or more pieces of augmented experience data in which at least a buffer occupancy rate bₜ₋₁ included in experience data is changed to a different value on a basis of the experience data including a state sₜ₋₁ that is a state of encoding of a (t-1)-th image included in a moving image and includes the buffer occupancy rate bₜ₋₁, a reward rₜ that represents an evaluation value of encoding of the (t-1)-th image, an action aₜ₋₁ obtained by a model that receives an input of the state sₜ₋₁ and outputs an action used for determining parameters of encoding, and a state sₜ that is a state of encoding of a t-th image included in the moving image and includes a buffer occupancy rate bₜ; and
learn the model using the experience data and the augmented experience data.

2. The information processing apparatus according to claim 1, wherein
the hardware processor is configured to:
calculate a buffer occupancy rate b′ₜ₋₁ obtained by changing the buffer occupancy rate bₜ₋₁ to a different value;
calculate a reward r′ₜ by using the buffer occupancy rate b′ₜ₋₁;
calculate a buffer occupancy rate b′ₜ by using the buffer occupancy rate b′ₜ₋₁; and
generate the augmented experience data in which the buffer occupancy rate bₜ₋₁, the reward rₜ, and the buffer occupancy rate bₜ included in the experience data are replaced with the buffer occupancy rate b′ₜ₋₁, the reward r′ₜ, and the buffer occupancy rate b′ₜ, respectively.

3. The information processing apparatus according to claim 2, wherein
the hardware processor is configured to calculate the buffer occupancy rate b′ₜ₋₁ on a basis of a value obtained by adding a random number to the buffer occupancy rate bₜ₋₁.

4. The information processing apparatus according to claim 2, wherein
the hardware processor is configured to calculate the buffer occupancy rate b′ₜ by using a model that receives inputs of the buffer occupancy rate b′ₜ₋₁, a network bandwidth, and a compressed data amount of one or more images before the (t-1)-th image and outputs the buffer occupancy rate b′ₜ.

5. The information processing apparatus according to claim 1, wherein
the reward rₜ is calculated to be smaller as a distortion generated by encoding increases and to be smaller as an amount of a buffer occupancy rate exceeding a threshold increases.

6. The information processing apparatus according to claim 2, wherein
the hardware processor is configured to:
output a designation screen for designating a setting value to be used for generation of the augmented experience data, and
generate the augmented experience data using the setting value designated by using the designation screen.

7. The information processing apparatus according to claim 6, wherein
the setting value includes a number of pieces of the augmented experience data to be generated and a method of changing the buffer occupancy rate bₜ₋₁ to a different value.

8. An information processing method executed by a computer of an information processing apparatus, the information processing method comprising:
generating one or more pieces of augmented experience data in which at least a buffer occupancy rate bₜ₋₁ included in experience data is changed to a different value on a basis of the experience data including a state sₜ₋₁ that is a state of encoding of a (t-1)-th image included in a moving image and includes the buffer occupancy rate bₜ₋₁, a reward rₜ that represents an evaluation value of encoding of the (t-1)-th image, an action aₜ₋₁ obtained by a model that receives an input of the state sₜ₋₁ and outputs an action used for determining parameters of encoding, and a state sₜ that is a state of encoding of a t-th image included in the moving image and includes a buffer occupancy rate bₜ; and
learning the model using the experience data and the augmented experience data.

9. A computer program product having a non-transitory computer readable medium including instructions stored thereon, wherein the instructions, when executed by a computer, cause the computer to execute:
generating one or more pieces of augmented experience data in which at least a buffer occupancy rate bₜ₋₁ included in experience data is changed to a different value on a basis of the experience data including a state sₜ₋₁ that is a state of encoding of a (t-1)-th image included in a moving image and includes the buffer occupancy rate bₜ₋₁, a reward rₜ that represents an evaluation value of encoding of the (t-1)-th image, an action aₜ₋₁ obtained by a model that receives an input of the state sₜ₋₁ and outputs an action used for determining parameters of encoding, and a state sₜ that is a state of encoding of a t-th image included in the moving image and includes a buffer occupancy rate bₜ; and
learning the model using the experience data and the augmented experience data.
